(19) United States
(12) Patent Application Publication
(10) Pub. No.: US 2006/0033341 A1
(43) Pub. Date: Feb. 16, 2006

(54) Waterwheel powered air delivery device

(76) Inventor: Michael J. Kaufman, Boswell, PA (US)

Correspondence Address: Richard C. Litman;LITMAN LAW OFFICES, LTD., P.O. Box 15035, Arlington, VA, 22215, US

(21) Appl. No.: 10/917,448

(22) Filed: Aug. 13, 2004

(51) Int. Cl. F03B 13/00; H02P 9/04

(52) U.S. Cl. 290/54

(57) ABSTRACT

The waterwheel powered air delivery device is a system for powering an air compressor, aerator, or other device that moves air from power produced by a waterwheel without the necessity of providing electricity from an outside power source or the intermediate production of electricity from the waterwheel. The waterwheel may be an overshot, undershot or sideshot waterwheel. The device being powered may be an air compressor, aerator, or other air delivery device having an air pump that may be of the diaphragm, piston, rotary vane, rotary screw or other type. Preferably the air produced by the waterwheel and air delivery device is used for aeration of wastewater, although the delivery device may be used for other purposes, e.g., ventilation, power, etc.

### BACKGROUND OF THE INVENTION

1. Field of the Invention

The present invention relates to water powered air compressors, aerators, and other air conveying devices, and more particularly to air delivery devices powered by a waterwheel run by flowing water.

2. Description of the Related Art

Wastewater treatment facilities use a variety of methods for removing environmental pollutants from wastewater. Frequently it is desirable to aerate the wastewater during treatment to aid in separating contaminants from the water (particularly noxious gases entrained in the wastewater), and to replace any oxygen depleted from the water upon discharge for the benefit of fish and wildlife. A further goal would be to aerate the water in an environmentally friendly manner by using an energy source that does not rely upon electricity derived from generators powered by fossil fuels. It is also sometimes necessary to treat wastewater in locations or localities where there is no readily available source of electricity, but where there is an abundant supply of water power, even though the water may be delivered at low pressure. The present invention is directed towards an air compressor, aerator, or other air conveyor or delivery device which is powered by a waterwheel.

U.S. Pat. No. 4,354,826, issued Dec. 21, 1982 to M. Kato, describes a plurality of honeycombed tubes mounted on a rotary shaft to form a “waterwheel” device for aerating water. The device does not describe the prime over for rotating the shaft.

Various patents disclose fans driven by water turbines for driving smoke from a burning building, including U.S. Pat. No. 4,907,654, issued Mar. 13, 1990, U.S. Pat. No. 4,976,319, issued Dec. 11, 1990, and U.S. Pat. No. 5,215,499, issued Jun. 1, 1993 to Eberhardt; and U.S. Pat. No. 5,013,214, issued May 7, 1991, and U.S. Pat. No. 5,125,797, issued Jun. 30, 1992 to D. Kapich.

U.S. Pat. No. 6,534,881, issued Mar. 18, 2003 to S. Slavchev, teaches a waterwheel that operates while entirely submerged. The waterwheel has a plurality of flexible air chambers disposed about the perimeter of the wheel that are inflated and deflated in sequence to impart rotation to the wheel through buoyancy effects.

U.S. Pat. No. 6,029,688, issued Feb. 29, 2000 to the present inventor, describes various embodiments of waterwheels, including overshot, undershot, and sideshot, to operate various types of pumps for chemical treatment of water, particularly in wastewater applications.

Agricola discusses fans for ventilating mines at pages 203-207 in Book VI of De Re Metallica, written in 1556 (1950 Dover Publications, Inc. ed., translated by Hoover et al.). The embodiment shown in the drawing at page 206 shows a fan powered by a waterwheel that forces air down a mineshaft through a conduit.

A web page published at homepage.ntlworld.com/b.fox5/alternative_energy_schemes.htm as of at least May 2, 2004 describes refurbishing of the Dolbantau Mill, including coupling a waterwheel directly to an air compressor used to sore compressed air in storage tanks for supplying power to a workshop without generating electricity. No details are provided regarding the type of waterwheel, the type of air compressor, or the coupling method.

A web page published on the World Wide Web at www.pointandsquirt.co.uk/justin/colorado_{—}10.html at least as of May 2, 2004 shows a photograph of the Marble Mill in the White River National Forest of Colorado, and particularly a compressor house and a waterwheel that was used to pump air into nearby mines along a pneumatic tube.

None of the above inventions and patents, taken either singly or in combination, is seen to describe the instant invention as claimed. Thus a waterwheel powered air compressor solving the aforementioned problems is desired.

### SUMMARY OF THE INVENTION

The waterwheel powered air delivery device is a system for powering an air compressor, aerator, or other device that moves air from power produced by a waterwheel without the necessity of providing electricity from an outside power source or the intermediate production of electricity from the waterwheel. The waterwheel may be an overshot, undershot or sideshot waterwheel. The device being powered may be an air compressor, aerator, or other air delivery device having an air pump that may be of the diaphragm, piston, rotary vane, rotary screw or other type. Preferably the air produced by the waterwheel and air delivery device is used for aeration of wastewater, although the delivery device may be used for other purposes, e.g., ventilation, power, etc.

The coupling between the waterwheel's central shaft and the air pump will depend upon the type of pump. Piston pumps, diaphragm pumps, and bellows pumps require a reciprocating drive, which may be provided by a disk concentrically mounted on a rotating shaft with a cam arm rotatably mounted between the disk and the pump's piston. Other pumps require a rotating drive that may be provided either by direct connection to the waterwheel's central shaft, by a gear train between the waterwheel's central shaft and the air pump, or by a chain and sprocket system connecting the waterwheel's central shaft with the pump.

For use in aerating wastewater, the air delivery device will include a system of pipe's or conduits which deliver the air into the wastewater by a nozzle including one or more discharge orifices.

This and other features of the present invention will become readily apparent upon further review of the following specification and drawings.

### BRIEF DESCRIPTION OF THE DRAWINGS

FIG. 1 is a diagrammatic perspective view of a waterwheel powered air delivery device according to the present invention in which the delivery device includes a rotary vane air pump.

FIG. 2 is a perspective view of an overshot waterwheel driving a tube pump for delivery of chemical treatment into a water stream according to the prior art.

FIG. 3 is a diagrammatic perspective view of an overshot waterwheel powering a rotary screw air compressor, together with an air storage tank and an air discharge nozzle for air delivery according to the present invention.

Similar reference characters denote corresponding features consistently throughout the attached drawings.

### DETAILED DESCRIPTION OF THE PREFERRED EMBODIMENTS

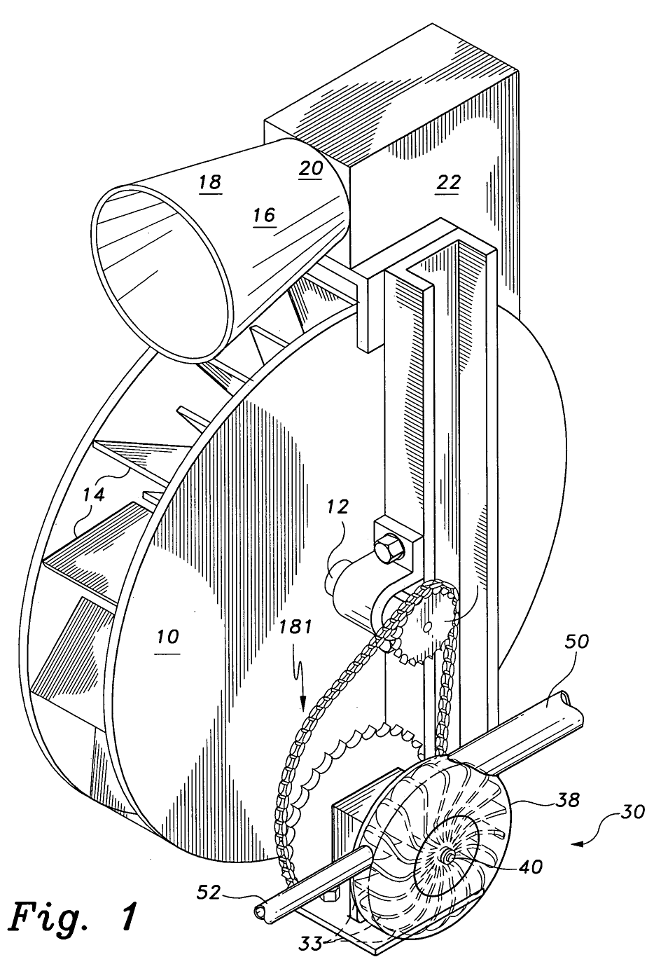

The present invention is a waterwheel powered air delivery device. As shown in FIG. 1, the system includes at least a waterwheel 10 and an air pump 30. The waterwheel 10 is of the type that is powered by a moving stream of water from a river, brook, creek, pond, stream, or other natural waterway, or from a millrace, flume, or other artificial channel of flowing water. The waterwheel 10 may be an overshot wheel, as shown in the drawings, a breast wheel, or where the head is not sufficient, an undershot or sideshot wheel. The air pump 30 may be a rotary vane pump, as shown in FIG. 1, a diaphragm pump, piston pump, rotary screw pump, or any other type of air pump. Acceptable types of waterwheels and air pumps for use with the present invention are shown and described in detail in my prior patent, U.S. Pat. No. 6,029,688, issued Feb. 29, 2000, which is hereby incorporated by reference in its entirety.

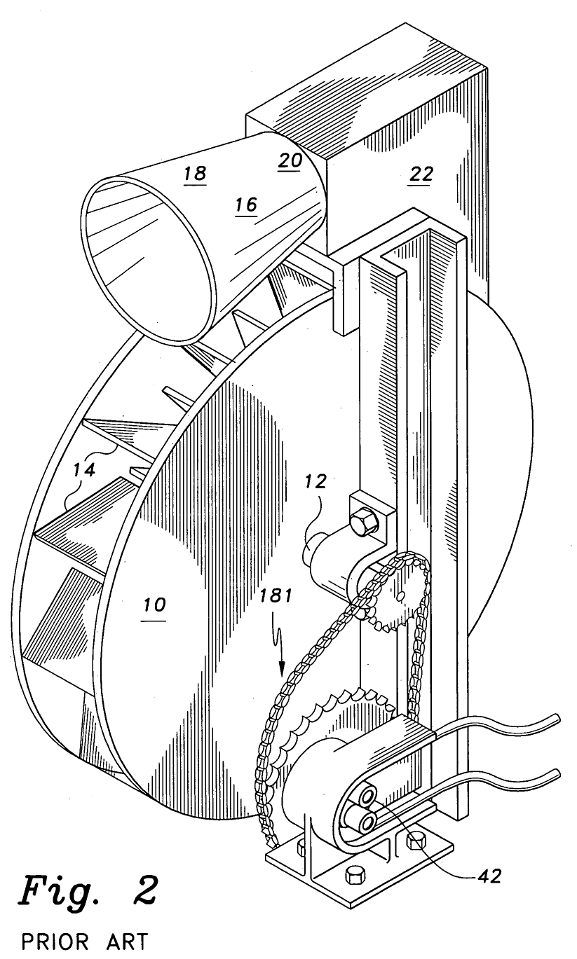

FIG. 2 shows a representative waterwheel as described in the '688 patent. The device includes an overshot waterwheel 10 mounted on rotatable central shaft 12 with buckets 14 driven by water impinging upon buckets 14. Water enters through inlet 16, which tapers from wide entrance 18 to a narrow section 20 and through vertical section 22 before discharging the water into buckets 14. Central shaft 12 is mounted in bearings on posts, uprights, or other supports so that shaft 12 rotates when the water is discharged into buckets 14. Power output from the rotating shaft 12 drives a tube pump 42 via a chain and sprocket drive mechanism 181. Tube pump 42 is a hydraulic pump for pumping a liquid chemical or chemical solution into a water stream.

FIG. 1 shows that the overshot waterwheel 10 of FIG. 1 can be easily adapted for powering an air delivery device. FIG. 1 shows the waterwheel mounted on rotatable shaft 12 with buckets 14 on the periphery. Again, water is directed through the wide mouth 18 of inlet 16 and narrow portion 20 into vertical section 22 and impacts buckets 14 to cause the wheel 10 to rotate. However, instead of a hydraulic pump, the power output from rotating shaft 12 is coupled to rotary vane air pump 30. Air pump 30 has vanes or blades 33 slidably mounted in grooves on rotor 40 disposed within housing 38. Rotor 40 is eccentrically mounted within cylindrical housing 38, or a portion of the housing 38 is flattened so that housing 38 does not define a perfectly cylindrical chamber. Vanes 33 slide outward by centrifugal force as the rotor 40 spins, and inward as the radial distance between the rotor 40 and the housing 38 contracts, so that the chamber size defined by the vanes 33 becomes smaller approaching discharge conduit 50, thereby compressing air admitted through intake conduit 52. Rotor 40 is coupled to central shaft 12 by chain and sprocket mechanism 181.

As previously mentioned, although FIG. 1 illustrates an overshot waterwheel coupled to a rotary vane air pump by a chain and sprocket mechanism, the waterwheel may be an overshot wheel, a breast wheel, an undershot wheel or a sideshot wheel, and the air pump may be a rotary vane pump, a diaphragm pump, piston pump, rotary screw pump, or any other type of air pump. The waterwheel may be coupled to the air pump by a chain and sprocket mechanism, by a reciprocating cam arm, by direct connection to the waterwheel's central shaft, or by a gear train, as described in my prior '688 patent.

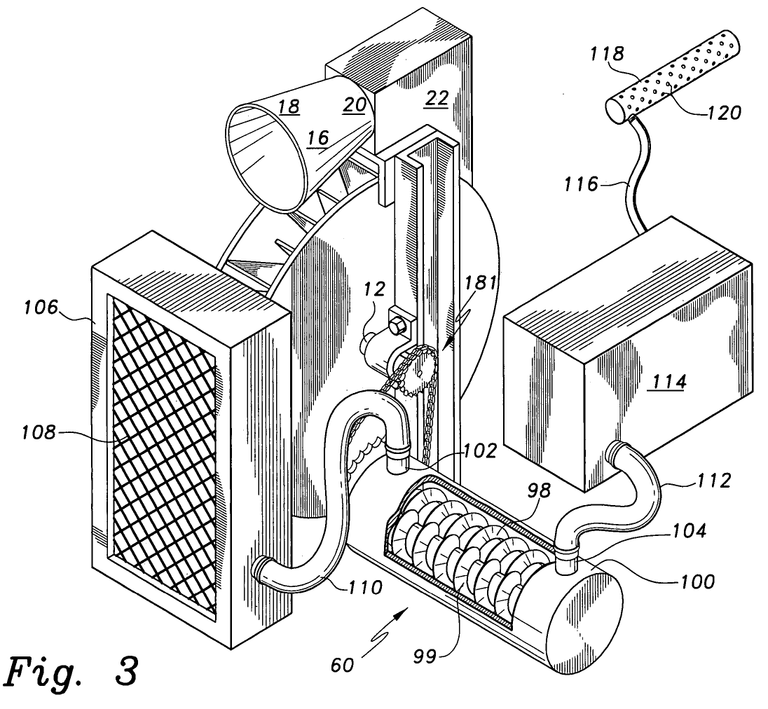

The output from the air pump may be attached directly to a nozzle, diffuser, or other aerating device, or may be stored in a compressed air tank. Referring to FIG. 3, an overshot waterwheel 10 is shown coupled to a rotary screw air pump 60. The rotary screw air pump 60 has opposing screws 98 and 99 disposed on housing 100. The drive screw 98 is coupled to the central shaft of waterwheel 10 by chain and sprocket mechanism 181. Air enters housing 100 through intake port 102 and leaves the housing through discharge port 104. Air may be supplied by a plenum 106 or manifold covered by a mesh screen 108 or the like and conveyed to intake port 102 by conduit 110, which may be rigid pipe, flexible tubing, or other suitable air conduit.

The drive screw 98 is driven by rotation of waterwheel 10 and central shaft 12, while the driven screw counterrotates by gear attachment to drive screw 98. Air is compressed and moved through housing 100 by the counterrotating screws 98 and 99, and leaves the housing through discharge port 104. FIG. 3 shows the discharged air conveyed by discharge conduit 112 to a compressed air storage tank 114. While storage tank 114 is shown diagrammatically as a separate component, it will be understood by those skilled in the art that when the air delivery device uses stored compressed air, the air pump 60 may be mounted directly on storage tank 114 to eliminate the need for an extended discharge conduit 112. It will further be understood that the compressor may be either a single-stage or a two-stage compressor to reduce heat loss from the compressor, and that the pump 60 and storage tank 114 may further comprise a shut-off valve, pressure relief valve, or other safety equipment commonly provided with air compressors.

The air delivery device may further include a delivery conduit 116 or air hose terminating in one or more nozzles 118, diffusers, or other devices having orifices 120 defined therein for releasing the compressed air as small air bubbles into a body of water, e.g., in a wastewater treatment facility, in order to aerate the body of water. Such aeration promotes the separation of noxious gases from the wastewater, as well as replenishing oxygen that may have been depleted by other wastewater treatment modalities in the wastewater treatment facility.

Alternatively, the compressed air stored in tank 114 may be used to power tools or machinery in a workshop or to provide power for other applications. It will also be understood that the power provided by waterwheel 10 may be used to power an aerator directly, without intermediate storage of compressed air, or to power a blower, fan, or other device for moving or delivering air.

It is to be understood that the present invention is not limited to the embodiments described above, but encompasses any and all embodiments within the scope of the following claims.

I claim:

1. A waterwheel powered air delivery device, comprising:
a waterwheel having a central shaft and a periphery, the central shaft being mounted in bearings on supports, whereby the waterwheel and the shaft are adapted for rotation when water moves against the periphery of the waterwheel;
an air delivery device for moving air, the air delivery device having a drive means for driving the delivery of air;
direct coupling means for coupling the central shaft to the drive means of the air delivery device directly.

2. The waterwheel powered air delivery device, wherein said air delivery device comprises an air pump.

3. The waterwheel powered air delivery device according to claim 2, further comprising an aerator connected to said air pump.

4. The waterwheel powered air delivery device according to claim 2, wherein said air pump is selected from the group consisting of a rotary vane pump, a rotary screw pump, a diaphragm pump, and a piston pump.

5. The waterwheel powered air delivery device according to claim 1, wherein said waterwheel is selected from the group consisting of an overshot wheel, an undershot wheel, and a sideshot wheel.

6. The waterwheel powered air delivery device according to claim 1, wherein said coupling means is selected from the group consisting of a chain and sprocket mechanism, a reciprocating cam arm, a gear train, and fixation on the central shaft.

7. The waterwheel powered air delivery device according to claim 1, wherein said air delivery device comprises an air compressor having an air pump and a storage tank.

8. The waterwheel powered air delivery device according to claim 7, further comprising an aerator attached to the air compressor.

9. The waterwheel powered air delivery device according to claim 7, wherein said air pump is selected from the group consisting of a rotary vane pump, a rotary screw pump, a diaphragm pump, and a piston pump.

10. The waterwheel powered air delivery device according to claim 7, wherein said waterwheel is selected from the group consisting of an overshot wheel, an undershot wheel and sideshot wheel.
